(19) United States
(12) Patent Application Publication
(10) Pub. No.: US 2022/0292450 A1
(43) Pub. Date: Sep. 15, 2022

(54) DELIVERY SUPPORT DEVICE, DELIVERY SUPPORT METHOD, AND STORAGE MEDIUM

(71) Applicant: NEC Corporation, Tokyo (JP)

(72) Inventor: Ryota BABA, Tokyo (JP)

(73) Assignee: NEC Corporation, Tokyo (JP)

(21) Appl. No.: 17/672,984

(22) Filed: Feb. 16, 2022

(30) Foreign Application Priority Data
Mar. 12, 2021 (JP) 2021-039799

(51) Int. Cl. G06Q 10/08

(52) U.S. Cl. CPC G06Q 10/0833; G06Q 10/0838

(57) ABSTRACT

A delivery support device according to an aspect of the present disclosure includes: at least one memory configured store instructions; and at least one processor configured to execute the instructions to: receive information on a delivery origin and information on a delivery destination; calculate a delivery time between the delivery origin and the delivery destination based on a multiple pick rate of receiving a plurality of delivery objects in one pickup from the delivery origin; and output the delivery time.

This application is based upon and claims the benefit of priority from Japanese Patent Application No. 2021-039799, filed on Mar. 12, 2021, the disclosure of which is incorporated herein in its entirety by reference.

### TECHNICAL FIELD

The present disclosure relates to a technology for providing information regarding delivery.

### BACKGROUND ART

JP 2004-227373 A discloses an order placement server that determines, from a plurality of stores in a chain store, a store that includes a delivery destination address in a delivery area and that requires the shortest time for delivery as a store that delivers an ordered product.

JP 2003 030550 A discloses an order reception system that calculates a delivery time required between receipt of an order via the Internet and delivery of a product on the basis of a parameter. Examples of the parameter include an order reception status of the product, a time zone in which the product is delivered, weather, delivery personnel, and traffic information. The order reception system of JP 2003 030550 A sets a sum of a product delivery time defined for each weather and a product preparation time defined according to the number of orders for each time zone as a delivery time.

JP 2005 148909 A discloses an order system that predicts a delivery time relevant to a current order time from accumulated past order times and delivery times, and outputs the predicted delivery time.

JP 2010 039961 A discloses a delivery operation support system that determines a delivery person on the basis of predicted times of pickup and delivery completion calculated for each delivery person on the basis of a pickup place and a delivery place of an article and a position and a status of each delivery person. The delivery operation support system corrects traveling time of the entire route on which the delivery person travels by using a correction value according to the weather, a correction value related to pickup or delivery preparation, a correction value according to an entrance difficulty level of a building of the pickup and delivery destination, and a correction value according to a delivery skill of the delivery person, thereby calculating a predicted time.

### SUMMARY

One example of an object of the present disclosure is to provide a delivery support device or the like that can improve accuracy of a predicted delivery time.

A delivery support device according to an aspect of the present disclosure includes: a reception unit that receives information on a delivery origin and information on a delivery destination; a calculation unit that calculates a delivery time between the delivery origin and the delivery destination on the basis of a multiple pick rate which is a probability of receiving a plurality of delivery objects in one pickup from the delivery origin; and an output unit that outputs the delivery time.

A delivery support method according to an aspect of the present disclosure includes: receiving information on a delivery origin and information on a delivery destination; calculating a delivery time between the delivery origin and the delivery destination on the basis of a multiple pick rate of receiving a plurality of delivery objects in one pickup from the delivery origin; and outputting the delivery time.

A non-transitory computer-readable storage medium according to an aspect of the present disclosure stores a program for causing a computer to execute: reception processing of receiving information on a delivery origin and information on a delivery destination; calculation processing of calculating a delivery time between the delivery origin and the delivery destination on the basis of a multiple pick rate of receiving a plurality of delivery objects in one pickup from the delivery origin; and output processing of outputting the delivery time.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration example of a delivery support device according to a first example embodiment of the present disclosure;

FIG. 2 is a flowchart illustrating an operation example of the delivery support device according to the first example embodiment of the present disclosure;

FIG. 3 is a block diagram illustrating a configuration example of a delivery support device according to a second example embodiment of the present disclosure;

FIG. 4 is a block diagram illustrating a configuration example of a delivery support system according to a second example embodiment of the present disclosure;

FIG. 5 is a flowchart illustrating an overall operation example of the delivery support device according to the second example embodiment of the present disclosure;

FIG. 6 is a flowchart illustrating an operation example of delivery information provision processing of the delivery support device according to the second example embodiment of the present disclosure;

FIG. 7 is a block diagram illustrating an operation example of order reception processing of the delivery support device according to the second example embodiment of the present disclosure;

FIG. 8 is a flowchart illustrating an operation example of delivery end processing of the delivery support device according to the second example embodiment of the present disclosure;

FIG. 9 is a diagram illustrating an example of scores of a plurality of delivery agents;

FIG. 10 is a diagram illustrating an example of scores set for a length of route; and

FIG. 11 is a diagram illustrating an example of a hardware configuration of a computer that can implement a delivery support device according to an example embodiment of the present disclosure.

### EXAMPLE EMBODIMENT

An example embodiment of the present disclosure will be described in detail below with reference to the drawings.

### First Example Embodiment

A first example embodiment of the present disclosure will be described in detail below with reference to the drawings.

<Outline>

A delivery support device 101 according to the first example embodiment of the present disclosure receives information on a delivery origin and information on a delivery destination input by a user, for example. The delivery support device 101 calculates a delivery time which is a time required for delivering a delivery object from the delivery origin to the delivery destination on the basis of a multiple pick rate in the delivery origin. The delivery support device 101 outputs a calculated delivery time.

<Configuration>

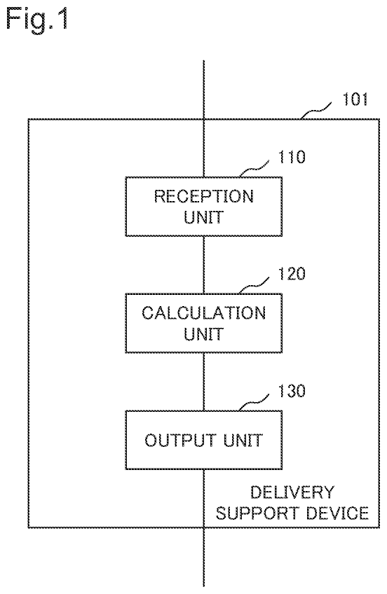

FIG. 1 is a block diagram illustrating a configuration example of the delivery support device 101 according to the first example embodiment of the present disclosure. In the example illustrated in FIG. 1, the delivery support device 101 includes a reception unit 110, a calculation unit 120, and an output unit 130. The reception unit 110 receives the information on the delivery origin and the information on the delivery destination. The calculation unit 120 calculates the delivery time between the delivery origin and the delivery destination on the basis of the multiple pick rate which is a probability of receiving a plurality of delivery objects in one pickup from the delivery origin. The output unit 130 outputs the delivery time.

In the description of an example embodiment of the present disclosure, the delivery origin is a place where a deliverer who delivers the delivery object receives the delivery object to be delivered to the delivery destination by the deliverer. The delivery destination is a place where the delivery agent delivers the delivery object delivered from the delivery origin by the deliverer. The delivery object is, for example, an object to be delivered such as food and drink. The delivery origin is, for example, a store of a company that provides delivery objects such as food and drink. The delivery destination is, for example, a delivery destination of the delivery object, which is designated by a delivery requester of the delivery object such as food and drink. The information on the delivery destination is information indicating a delivery destination place (for example, address). The information on the delivery origin is, for example, information including a delivery destination place (address or the like). The information on the delivery origin may include information on a name of the delivery origin. In the following description, receiving a plurality of delivery objects having different delivery destinations in one pickup from the delivery origin is referred to as a multiple pick. In the description of an example embodiment of the present disclosure, a plurality of delivery objects having the same delivery destination is regarded as one delivery object. The multiple pick rate is a probability that the pickup of the delivery object is a multiple pick. In other words, the multiple pick rate is a probability of occurrence of a multiple pick in receiving the delivery object. In the following description, the multiple pick rate is also referred to as a double pick occurrence rate particularly when the number of delivery objects to be received is two.

The reception unit 110 may further receive a time of delivery. In addition to the multiple pick rate, the calculation unit 120 may calculate the delivery time on the basis of the distance of the route from the delivery origin to the delivery destination, the traffic condition of the route in the time zone in which the delivery is performed, and the like. The multiple pick rate may be calculated in advance on the basis of, for example, information on the delivery origin, information of on a deliverer existing around the delivery origin, information on a delivery object that has not been received by a deliverer at the delivery origin, and the like. An example of a method of calculating the multiple pick rate will be described in detail later. An example of a method of calculating the delivery time based on the multiple pick rate also will be described in detail later.

<Operation>

Operation of the delivery support device 101 according to the first example embodiment of the present disclosure will be described in detail below with reference to the drawings.

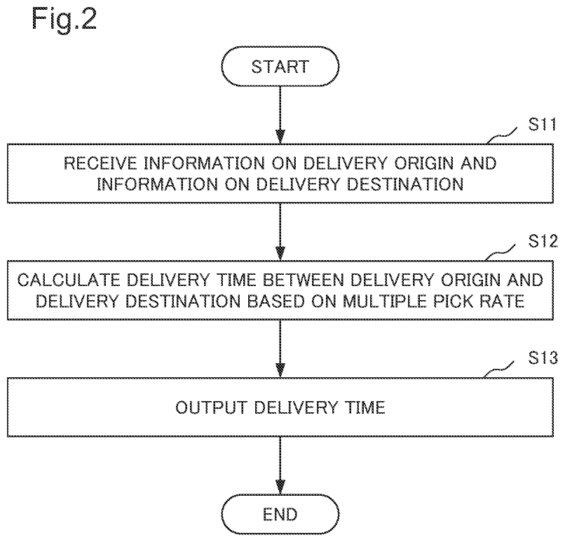

FIG. 2 is a flowchart illustrating an operation example of the delivery support device 101 according to the first example embodiment of the present disclosure. In the example illustrated in FIG. 2, first, the reception unit 110 receives the information on the delivery origin and the information on the delivery destination (step S11). Then, the calculation unit 120 calculates the delivery time between the delivery origin and the delivery destination on the basis of the multiple pick rate (step S12). The output unit 130 outputs a calculated delivery time (step S13).

<Effect>

The present example embodiment has an effect of improving accuracy of a delivery prediction time. This is because the calculation unit 120 calculates the delivery time between the delivery origin and the delivery destination on the basis of the multiple pick rate. In general, in a case where the delivery object is received by the multiple pick, it is necessary to deliver the delivery objects to a plurality of sending destinations. Therefore, the time required to deliver the delivery objects to the second and subsequent delivery destinations needs to be longer than the time required to deliver the delivery object in a case where one delivery object is delivered to one delivery destination. Accordingly, by calculating the delivery time based on the multiple pick rate, accuracy of the calculated delivery time, that is, the predicted time of the delivery, is improved.

### Second Example Embodiment

A second example embodiment of the present disclosure will be described in detail below with reference to the drawings.

<Configuration>

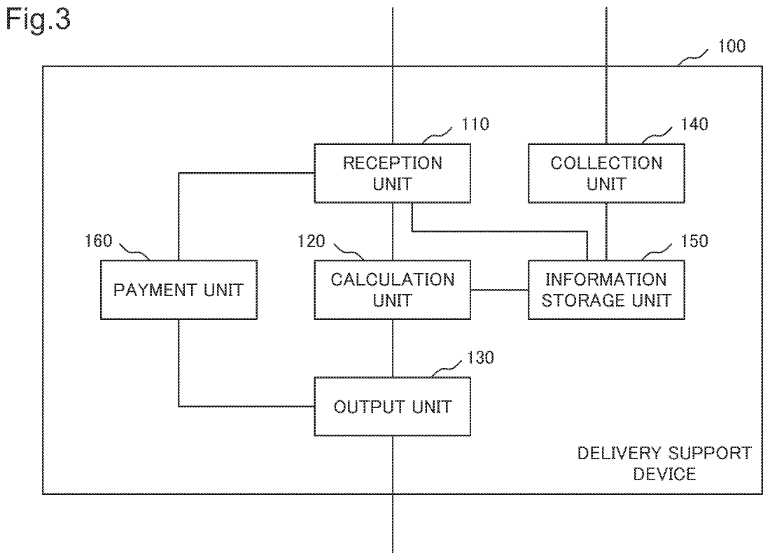

FIG. 3 is a block diagram illustrating a configuration example of a delivery support device 100 according to a second example embodiment of the present disclosure. In the example illustrated in FIG. 3, the delivery support device 100 includes a reception unit 110, a calculation unit 120, an output unit 130, a collection unit 140, an information storage unit 150, and a payment unit 160.

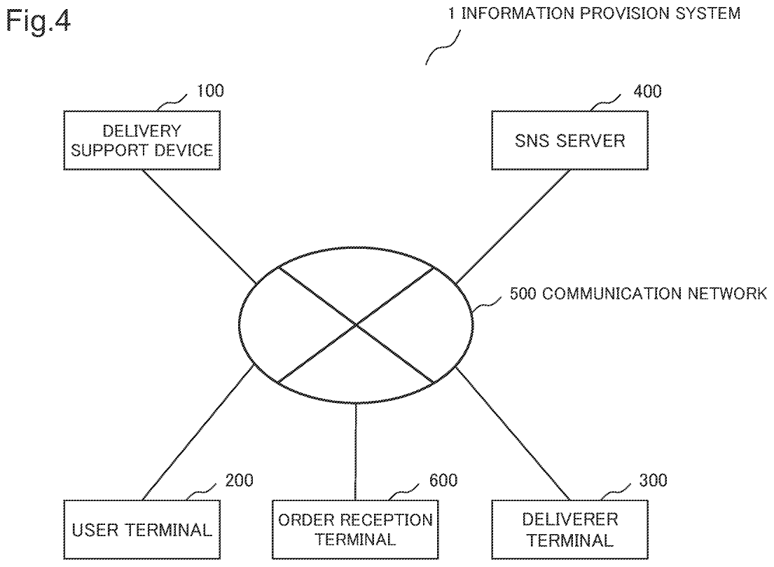

FIG. 4 is a block diagram illustrating a configuration example of a delivery support system 1 according to the second example embodiment of the present disclosure. In the example illustrated in FIG. 4, the delivery support system 1 includes the delivery support device 100, a user terminal 200, a deliverer terminal 300, and an order reception terminal 600. The delivery support system 1 may include a plurality of user terminals 200. The delivery support system 1 may include a plurality of deliverer terminals 300. The delivery support device 100 is connected to each of the user terminal 200, the deliverer terminal 300, and the order reception terminal 600 via a communication network 500. The delivery support device 100 is further connected to an SNS server 400 that provides a service of a social networking service (SNS) on which the deliverer can post, via the communication network 500. The delivery support system 1 may include an SNS server 400. The delivery support system 1 may include a plurality of SNS servers 400.

<User Terminal 200>

The user terminal 200 is an information processing device such as a personal computer or a smartphone used by a user.

The user inputs designation of an order candidate to the user terminal 200 using an input device such as a keyboard, a mouse, or a touch panel of the user terminal 200. The order candidate is a delivery object for which the user intends to know the delivery end time. The information on the order candidate is information designating the delivery object and the delivery destination. The designation of the order candidate is, for example, information including information on the delivery origin, information on the delivery object, and information on the delivery destination. The user terminal 200 may receive a combination of the delivery origin and the delivery object and display information indicating the received combination. The user terminal 200 may transmit the information on the delivery origin and the information on the delivery object selected by the user on the basis of the displayed combination, and for example, the information on the delivery destination registered in advance to the delivery support device 100 as designation of the order candidate described above.

The user terminal 200 receives the delivery time for the combination of the delivery origin and the delivery object from the delivery support device 100, and displays the received delivery time. For example, the user terminal 200 transmits order information determined by the user using the input device according to the display of the delivery time to the delivery support device 100. The order information is information for specifying the delivery object for which the user requests the delivery and the delivery destination, and paying the delivery charge of the delivery object. The order information is, for example, information including information on the delivery origin, information on the delivery object, information on the delivery destination, and payment information.

The information on the delivery object is, for example, information for specifying the delivery object such as food and drink. The information on the delivery origin is, for example, information capable of specifying a delivery origin place. The information capable of specifying the delivery origin place may be, for example, information indicating an address of the delivery origin. In a case where the delivery origin place can be specified by the information specifying the company, the information on the delivery origin may be information specifying the company. In a case where the delivery origin place can be specified by the information specifying the store, the information on the delivery origin may be information specifying the store. The information on the delivery destination is, for example, information for specifying a delivery destination place. The information specifying the delivery destination place is, for example, information indicating a delivery destination address. In a case where the information for specifying the delivery destination place is associated with the information specifying the user, the information on the delivery destination may be information for specifying the user.

The payment information is information for payment. The information for payment includes, for example, an amount of the delivery charge of the delivery object and information for payment. The information for payment may be, for example, information necessary for payment by a credit card including a credit card number. The information for payment may be, for example, information representing a quick response (QR) code (registered trademark) for QR code payment. The information for payment may be, for example, information for online payment using electronic money with a contactless integrated circuit (IC) card. The information for payment is not limited to these examples.

When order information is input, the user terminal 200 transmits the input order information to the delivery support device 100.

<Deliverer Terminal 300>

The deliverer terminal 300 is an information processing device such as a personal computer or a smartphone used by a deliverer.

The deliverer inputs deliverer information to the deliverer terminal 300 using an input device such as a keyboard, a mouse, or a touch panel of the deliverer terminal 300. The deliverer information includes, for example, a type of delivery service to which the deliverer belongs (for example, information specifying a delivery agent, and the like), a delivery section (for example, walking, bicycle, two-wheeled automobile, four-wheeled automobile, or the like), and information on delivery availability indicating whether delivery can be currently performed. When deliverer information is input, the deliverer terminal 300 transmits the input deliverer information to the delivery support device 100.

In a case where the delivery of the delivery object is completed, the deliverer inputs information specifying the delivery object for which the delivery is completed and the time when the delivery is completed to the deliverer terminal 300. In a case where the information specifying the delivery object for which the delivery is completed and the time when the delivery is completed are input, the deliverer terminal 300 transmits a delivery end notification including the information specifying the delivery object for which the delivery is completed and the time when the delivery is completed to the delivery support device 100.

The deliverer terminal 300 periodically specifies the position of the deliverer (specifically, for example, the deliverer terminal 300 held by the deliverer), for example, and transmits position information indicating the specified position to the delivery support device 100. In response to the request for position information from the delivery support device 100, the deliverer terminal 300 may specify the position of the deliverer terminal 300 and transmit the specified position information to the delivery support device 100.

The deliverer can post a comment to the SNS service provided by the SNS server 400 described later using the deliverer terminal 300. Specifically, the deliverer terminal 300 receives the comment input by the deliverer using the input device of the deliverer terminal 300, and transmits the received comment to the SNS server 400. The posted comment may include, for example, a comment regarding the delivery origin. Specifically, the posted comment may include information indicating whether the delivery request from the delivery origin has been accepted or rejected. The deliverer terminal 300 may receive the comment posted on the SNS server 400 and stored in the SNS server 400 from the SNS server 400 according to the instruction by the deliverer.

<SNS Server 400>

The SNS server 400 provides an SNS service capable of posting comments (specifically, receiving, storing, and providing comments and the like by the user and the deliverer) and the like by the deliverer. Specifically, the SNS server 400 receives the comment input by the deliverer from the deliverer terminal 300 and stores the received comment. When receiving the comment request, the SNS server 400 transmits the stored comment to the device (for example, the deliverer terminal 300, the delivery support device 100, and the like) that has transmitted the request.

<Order Reception Terminal 600>

The order reception terminal 600 receives the information on the delivery object from the delivery support device 100. The order reception terminal 600 is an information processing device such as a personal computer or a smartphone held by a provider of the delivery object. When receiving the information on the delivery object, the order reception terminal 600 notifies the provider of the delivery object of the information on the delivery object. In a case where the information on the delivery object is notified, the provider of the delivery object starts preparation of the delivery object in order to transfer the delivery object to the deliverer.

<Delivery Support Device 100>

Hereinafter, the components of the delivery support device 100 will be described in detail.

<Reception Unit 110>

The reception unit 110 receives an order candidate from the user terminal 200. The reception unit 110 transmits the received order candidate to the calculation unit 120. The output unit 130 described later may output a combination of the information on the delivery origin and the information on the delivery object to the user terminal 200. The reception unit 110 may receive, from the user terminal 200, an order candidate including information on each of the delivery origin and the delivery object selected from the delivery origin and the delivery object for which the information has been output, and a time at which the order candidate has been received.

The reception unit 110 further receives order information from the user terminal 200. The reception unit 110 stores the received order information in the information storage unit 150. The reception unit 110 transmits the received order information to the payment unit 160. The output unit 130 described later may output a delivery time with respect to a combination of the information on the delivery origin and the information on the delivery object to the user terminal 200. The reception unit 110 may receive the order information determined with reference to the display of the delivery time for the combination of the information on the delivery origin and the information on the delivery object.

The reception unit 110 may receive delivery completion information (for example, a combination of the information on the delivery object whose delivery is completed and the information on the time when the delivery is completed) from the deliverer terminal 300. When receiving the delivery completion information, the reception unit 110 adds information on the time when the delivery is completed to the order information of the delivery object for which the delivery is completed stored in the information storage unit 150.

<Collection Unit 140>

The collection unit 140 collects comments regarding the delivery origin from the SNS server 400, and stores the collected comments in the information storage unit 150.

<Information Storage Unit 150>

The information storage unit 150 stores the order information received from the reception unit 110. The information storage unit 150 further stores the comment regarding the delivery origin collected by the collection unit 140. The information storage unit 150 stores the position and state of the deliverer.

<Calculation Unit 120>

The calculation unit 120 receives the order candidate from the reception unit 110. As described above, the order candidate includes information on the delivery origin, information on the delivery object, and information on the delivery destination.

The calculation unit 120 extracts, from the comments stored in the information storage unit 150, a comment indicating whether the request for delivery of the object to be sent from the sender specified by the information of the sender included in the order candidate has been accepted or rejected. The comment may include a flag indicating whether the delivery request of the object to be sent from the sender has been accepted or rejected. The comment may indicate by text whether the delivery request of the object to be sent from the sender has been accepted or rejected. In that case, the calculation unit 120 may analyze the text of the comment to determine whether the comment indicates that the request for delivery of the object to be sent from the sender has been accepted or rejected. For example, the calculation unit 120 calculates, as the rejection rate, a ratio of the comment indicating that the request for delivery of the object to be sent from the sender is rejected among the extracted comments. The rejection rate represents a rate at which the delivery request is rejected.

The calculation unit 120 calculates the multiple pick rate which is a probability of receiving a plurality of delivery objects in one pickup of the delivery objects at the delivery destination. For example, the calculation unit 120 may calculate the multiple pick rate on the basis of the number of deliverers whose distance from the delivery origin indicated by the order candidate satisfies a first criterion and the number of delivery requests for which delivery is not completed to a delivery destination that has a distance from the delivery destination indicated by the order candidate satisfying a second criterion.

The calculation unit 120 may determine that the first criterion is satisfied when the distance from the position of the deliverer to the delivery origin place is shorter than a predetermined first distance. The calculation unit 120 may determine that the first criterion is satisfied when the time required for movement from the position of the deliverer to the delivery origin place is shorter than a predetermined first time. The calculation unit 120 may determine that the second criterion is satisfied when the distance from the delivery destination to another delivery destination is shorter than a predetermined second distance. The calculation unit 120 may determine that the second criterion is satisfied when the time required for movement from the delivery destination to another delivery destination is shorter than a predetermined second time. The first distance and the second distance may be appropriately determined. The first time and the second time may be determined in advance. The number of delivery requests for which the delivery is not completed may be the number of pieces of order information to which the time when the delivery is completed is not added among pieces of the order information stored in the information storage unit 150.

For example, the calculation unit 120 may estimate the multiple pick rate by using an estimator for estimating the multiple pick rate from the number of deliverers whose distance from the delivery origin satisfies a first criterion and the number of delivery requests for which delivery is not completed to a delivery destination that has a distance from the delivery destination satisfying a second criterion. For example, such an estimator is trained to receive the number of deliverers whose distance from the delivery origin satisfies a first criterion and the number of delivery requests for which delivery is not completed to a delivery destination that has a distance from the delivery destination satisfying a second criterion, and provide an estimated multiple pick rate.

The calculation unit 120 may calculate the multiple pick rate by another method.

For example, the calculation unit 120 calculates the delivery time required for delivery of the delivery object from the delivery origin to the delivery destination on the basis of the distance from the position of the deliverer to the delivery origin, the distance from the delivery origin to the delivery destination, the preparation time required for preparation of the delivery object, the rejection rate, and the multiple pick rate. For example, the calculation unit 120 may calculate the delivery time on the basis of the traffic state of the route from the position of the deliverer to the delivery origin, the traffic state of the route from the delivery origin to the delivery destination, the weather, the degree of congestion of the delivery origin, the transportation means of the deliverer, and the like.

Specifically, when rejection and a multiple pick do not occur, the calculation unit 120 calculates the time between when the delivery request for the delivery object is made and when the delivery object is delivered to the delivery destination. More specifically, the calculation unit 120 calculates a standard time required for the deliverer to move the distance from the position of the deliverer to the delivery origin. The calculation unit 120 further calculates a standard time between when the delivery of the delivery object is ordered and when the delivery of the delivery object becomes possible. The calculation unit 120 further calculates a standard time required for the deliverer to move from the delivery origin to the delivery destination. The calculation unit 120 selects a longer time from the standard time required for the deliverer to move the distance from the position of the deliverer to the delivery origin and the standard time between when the delivery of the delivery object is ordered and when the delivery of the delivery object becomes possible. The calculation unit 120 calculates a sum of the selected time, a predetermined standard time required for the deliverer to receive the delivery object at the delivery origin, and a standard time required for the deliverer to move from the delivery origin to the delivery destination. The calculation unit 120 sets the calculated sum as a time between when the delivery request of the delivery object is made and when the delivery object is delivered to the delivery destination. The calculation unit 120 may use a constant multiple of the calculated sum or a value obtained by adding a constant to the calculated sum as a time (that is, the delivery time) between when the delivery request for the delivery object is made and when the delivery object is delivered to the delivery destination.

The multiple pick rate may be calculated for each number of delivery objects received in one pickup of the delivery objects. An upper limit of the number of delivery objects to be received for one pickup may be determined. In this case, the calculation unit 120 sets the multiple pick rate for the number exceeding the upper limit to 0. When the multiple pick rate for a certain number is equal to or less than a predetermined probability, the calculation unit 120 may set the multiple pick rate for the number to 0.

The calculation unit 120 further calculates the delivery time for each order of delivery of the delivery object when a multiple pick occurs. For example, when there is a possibility of receiving two delivery objects by one pickup at the delivery origin, the calculation unit 120 calculates a delivery time when the delivery object delivered to the delivery destination is delivered first and a delivery time when the delivery object delivered to the delivery destination is delivered second. The calculation unit 120 may set the delivery time when a multiple pick does not occur as the delivery time when the delivery object delivered to the delivery destination is delivered first. The calculation unit 120 may set the time obtained by adding a predetermined time to the delivery time when a multiple pick does not occur as the delivery time when the delivery object delivered to the delivery destination is delivered first.

The calculation unit 120 may calculate in advance an increase rate or an increase time of the delivery time when the delivery object delivered to the past delivery destination is delivered second from the delivery time when the delivery object delivered to the delivery destination is delivered first. The calculation unit 120 may set, as the delivery time when the delivery object delivered to the delivery destination is delivered second, a time increased from the delivery time when the delivery object delivered to the delivery destination is delivered first according to an increase rate or an increase time calculated in advance. In this case, the calculation unit 120 may set the probability that the delivery object delivered to the delivery destination is delivered first and the probability that the delivery object delivered to the delivery destination is delivered second to be ½ of the probability of receiving two delivery objects by one pickup at the delivery origin.

The calculation unit 120 may similarly calculate the delivery completion time and the probability for each order of delivery also when there is a possibility of receiving three or more delivery objects by one pickup.

The calculation unit 120 may calculate the delivery time as described above for each deliverer whose distance from the delivery origin satisfies the first criterion. The calculation unit 120 selects a deliverer with the shortest delivery time. When the multiple pick rate is not 0, the calculation unit 120 selects a deliverer with the shortest delivery time when the delivery object is delivered first among the delivery objects received at the same time. The calculation unit 120 sets the delivery time when the delivery object is delivered first among the delivery objects received at the same time as the delivery time of the deliverer when the order of the delivery times of the deliverer is determined.

In the present example embodiment, when the rejection rate of the selected deliverer is 0, the calculation unit 120 does not select any more deliverer.

When the rejection rate of the selected deliverer is not zero, each probability for the delivery time of the deliverer with the shortest delivery time is multiplied by a value obtained by subtracting 1 from the rejection rate of the deliverer with the shortest delivery time. The calculation unit 120 further selects a deliverer with the second shortest delivery time. The calculation unit 120 multiplies each of the probabilities calculated for the delivery time of the deliverer with the second shortest delivery time by the rejection rate of the deliverer with the shortest delivery time.

When the rejection rate of the deliverer with the second shortest delivery time is not zero, each probability for the delivery time of the deliverer with the second shortest delivery time is multiplied by a value obtained by subtracting 1 from the rejection rate of the deliverer with the second shortest delivery time. The calculation unit 120 further selects a deliverer with the third shortest delivery time. As similar to this, the calculation unit 120 multiplies each probability calculated for the delivery time of the deliverer with the third shortest delivery time by the rejection rate of the deliverer with the second shortest delivery time.

The calculation unit 120 may repeat the selection of the deliverer and the calculation of the probability until all the deliverers whose distances from the delivery origin satisfy the first criterion are selected or the probability multiplied by the rejection rate does not exceed the predetermined probability.

The calculation of the delivery time and the probability by the calculation unit 120 is not limited to the above example.

The calculation unit 120 further calculates a delivery charge of the delivery object for each deliverer. Specifically, the calculation unit 120 calculates, as the delivery charge of the delivery object, the sum of the charge of the delivery object and the charge for the deliverer to deliver the delivery object from the delivery origin to the delivery destination. The charge for the delivery object and the charge for the deliverer to deliver the delivery object from the delivery origin to the delivery destination may be provided in advance by the calculation unit 120 of the delivery support device 100.

<Payment Unit 160>

The payment unit 160 receives the order information from the reception unit 110, and performs payment online according to the payment information included in the received order information. The method of performing payment online may be any one or more of various existing methods.

When the payment is successful, the payment unit 160 transmits order information and information indicating that the payment is successful to the output unit 130.

<Output Unit 130>

The output unit 130 outputs the information indicating the deliverer, the delivery time, the probability, and the charge calculated by the calculation unit 120. The information indicating the probability may be a value of the probability. The information indicating the probability may be other information (graphic, character, numerical, or the like) indicating the magnitude of the value of the probability.

When receiving the order information and the information indicating that the payment is successful from the payment unit 160, the output unit 130 transmits the information on the delivery object in the order information to the reception terminal 600. The output unit 130 further transmits information on the delivery origin, information on the delivery object, and information on the delivery destination in the order information to the deliverer terminal 300.

<Operation>

Operation of the delivery support device 100 according to the second example embodiment of the present disclosure will be described in detail below with reference to the drawings.

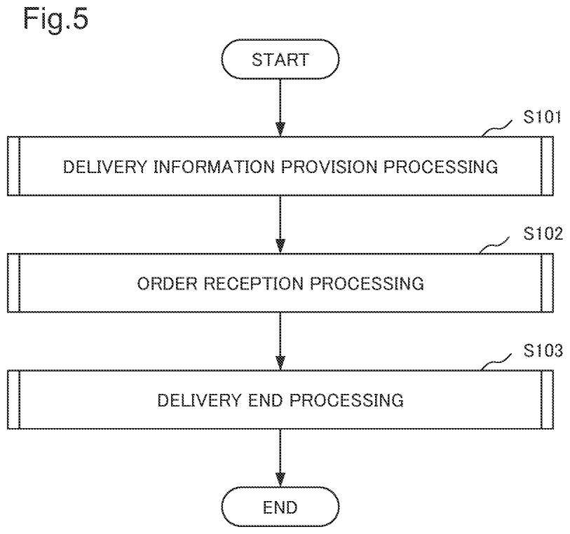

FIG. 5 is a flowchart illustrating an overall operation example of the delivery support device 100 according to the second example embodiment of the present disclosure. In the example illustrated in FIG. 5, the delivery support device 100 first performs delivery information provision processing (step S101). Next, the delivery support device 100 performs order reception processing (step S102). Lastly, the delivery support device 100 performs delivery end processing (step S103). The delivery information provision processing, the order reception processing, and the delivery end processing will be described in detail below.

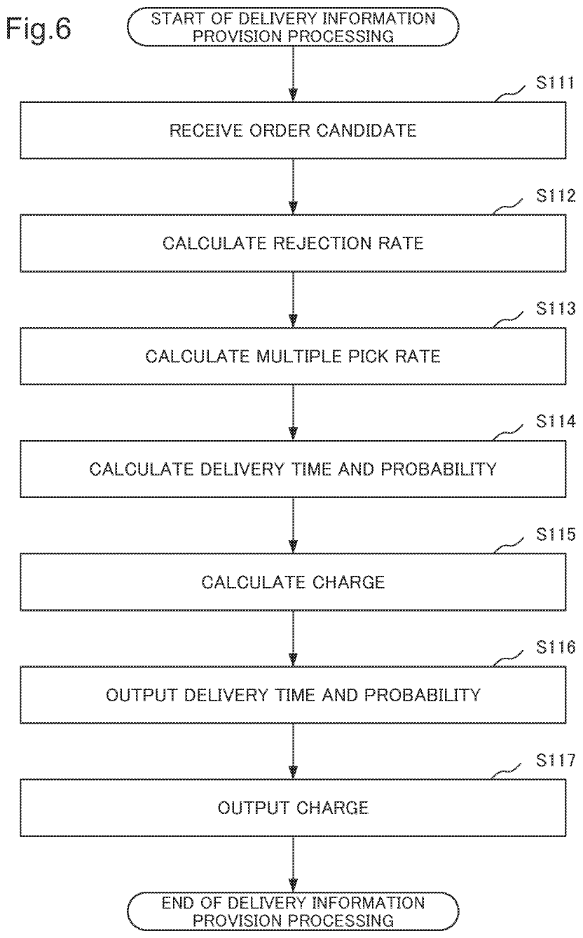

FIG. 6 is a flowchart illustrating an operation example of delivery information provision processing of the delivery support device 100 according to the second example embodiment of the present disclosure.

In the example illustrated in FIG. 6, first, the reception unit 110 receives an order candidate (step S111).

Then, the calculation unit 120 calculates a rejection rate for each deliverer satisfying the first criterion, for example (step S112). The calculation unit 120 calculates a multiple pick rate for each deliverer satisfying the first criterion, for example (step S113). The calculation unit 120 calculates the delivery time and the probability for each deliverer (step S114). For example, when the multiple pick rate is equal to or greater than a predetermined probability, the calculation unit 120 calculates the delivery time and the probability for each order in which the delivery objects are delivered. The calculation unit 120 calculates a charge for delivering the delivery object (step S115).

Then, the output unit 130 outputs the calculated delivery time and the information indicating the probability to the user terminal 200 (step S116). The output unit 130 outputs the charge for delivering the delivery object to the user terminal 200 (step S117).

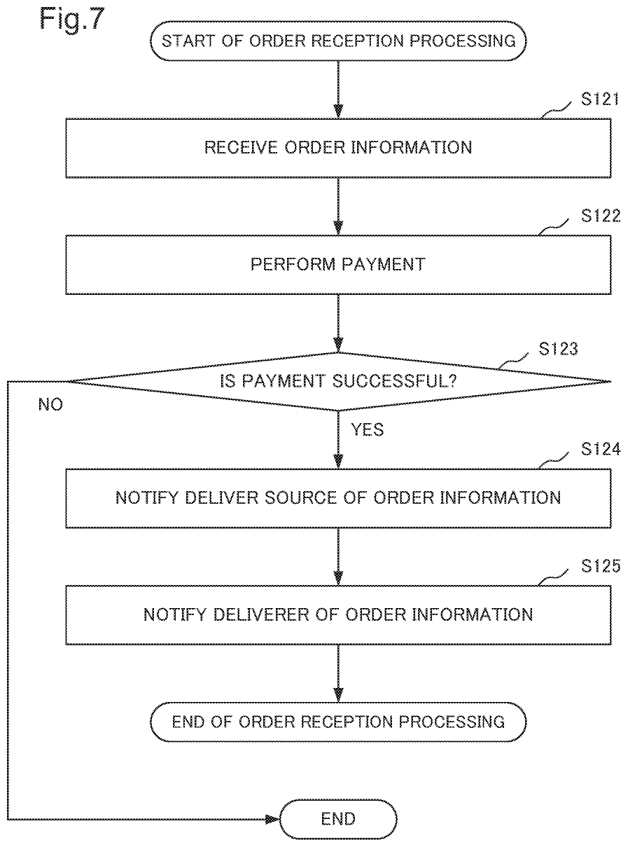

FIG. 7 is a block diagram illustrating an operation example of order reception processing of the delivery support device 100 according to the second example embodiment of the present disclosure.

In the example illustrated in FIG. 7, first, the reception unit 110 receives order information (step S121). Then, the payment unit 160 performs payment (step S122). When the payment is not successful (NO in step S123), the operation of the delivery support device 100 illustrated in FIG. 7 is ended, and the operation of the delivery support device 100 illustrated in FIG. 5 is also ended.

When the payment is successful (YES in step S123), the output unit 130 notifies the delivery origin of the order information (step S124). Specifically, the output unit 130 transmits the order information to the reception terminal 600, and the reception terminal 600 notifies the provider of the delivery object of the order information. In step S124, the output unit 130 may transmit information indicating the delivery object in the order information to the reception terminal 600.

Then, the output unit 130 notifies the deliverer of the order information (step S125). Specifically, the output unit 130 transmits the order information to the deliverer terminal 300, and the deliverer terminal 300 notifies the deliverer of the order information. In step S125, the output unit 130 may transmit information on the delivery origin, information on the delivery object, and information on the delivery destination in the order information to the deliverer terminal 300.

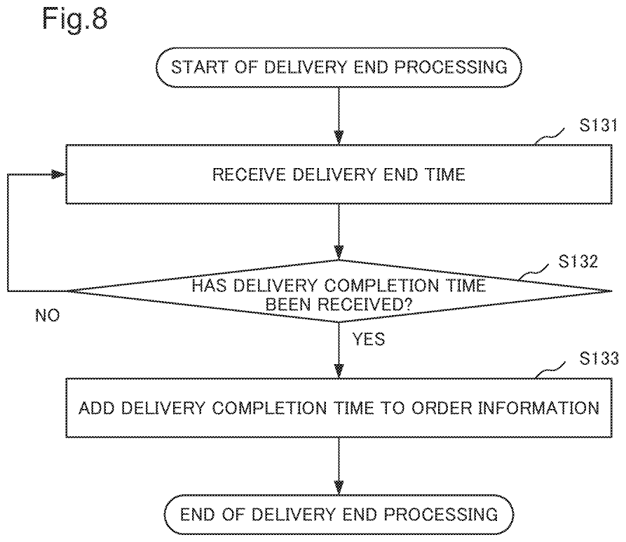

FIG. 8 is a flowchart illustrating an operation example of delivery end processing of the delivery support device 100 according to the second example embodiment of the present disclosure.

In the example illustrated in FIG. 8, first, when the delivery of the delivery object is completed, the deliverer inputs the delivery end time to the deliverer terminal 300. The deliverer terminal 300 transmits the delivery end time of the delivery object to the delivery support device 100. The reception unit 110 receives the delivery end time of the delivery object from the deliverer terminal 300 (step S131).

When the delivery end time of the delivery object has not been received (NO in step S132), the operation of the delivery support device 100 returns to step S131. When the delivery end time is received (YES in step S132), the reception unit 110 adds the received delivery end time to the order information of the delivery object stored in the information storage unit 150 (step S133). Then, the delivery support device 100 ends the operation illustrated in FIG. 8. In the example embodiment of the present disclosure, when the delivery end time is added to the order information of the delivery object stored in the information storage unit 150, it is considered that the delivery of the delivery object has ended.

<Effect>

The present example embodiment has the same effect as that of the first example embodiment. The reason is the same as the reason why the effect of the first example embodiment occurs.

<Modification>

The above-described deliverer may be a delivery agent. When there are a plurality of deliverers belonging to the same delivery agent, the calculation unit 120 may set a short delivery time among delivery times of a plurality of deliverers belonging to the same delivery agent as the delivery time of the delivery agent. In these cases, the output unit 130 may output the delivery time for each delivery agent.

When the user receives the delivery object, the user may input that the user has received the delivery object using the user terminal 200. In this case, the user terminal 200 transmits a notification of receipt of the delivery object to the reception unit 110 of the delivery support device 100. Upon receiving the notification of receipt of the delivery object, the reception unit 110 adds the time at which the notification of receipt of the delivery object has been received to the order information of the delivery object as the delivery end time at which the delivery of the delivery object has ended.

The reception unit 110 may set, as the delivery end time of the delivery object, an earlier one of the time when the notification of receipt of the delivery object is received from the user terminal 200 and the delivery end time of the delivery object received from the deliverer terminal 300.

The calculation unit 120 may calculate a score based on the delivery time. The score based on the delivery time may be, for example, a score based on the average delivery time, the rejection rate, the multiple pick rate (when it is set not to receive more than two delivery objects in one pickup, the multiple pick rate is also referred to as a double pick occurrence rate), and the like.

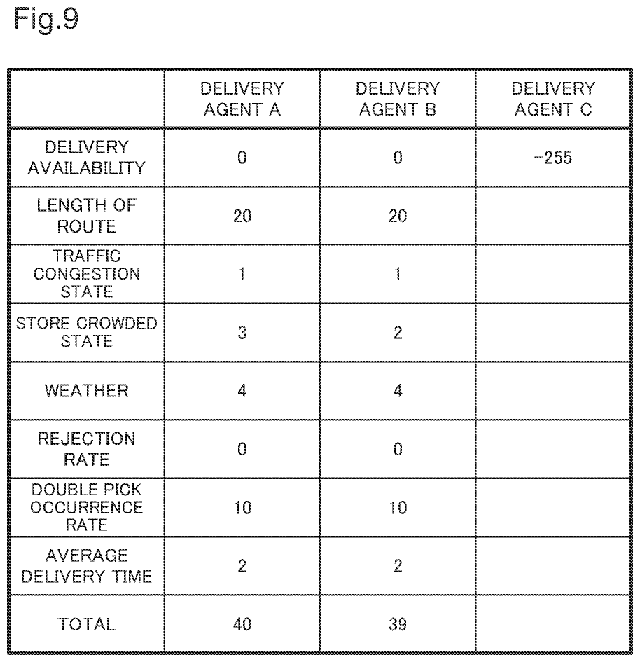

FIG. 9 is a diagram illustrating an example of scores of a plurality of delivery agents. In the example illustrated in FIG. 9, each of the delivery agents is a deliverer. A total of scores for delivery availability, a length of route, a traffic congestion state, a store crowded state, weather, a rejection rate, a double pick occurrence rate, and an average delivery time is set as the score of the delivery agent. Individual scores are determined according to a predetermined rule. The length of route is, for example, the length of route from the position of the delivery agent to the delivery destination via the delivery origin. The calculation unit 120 calculates a route using, for example, a technology of calculating a route from map data in a general navigation system. The calculation unit 120 may use, as the score of the traffic congestion state and the score of the store crowded state, for example, scores based on the traffic congestion state and the store crowded state for each time zone obtained in advance. For example, the collection unit 140 collects weather information for each area from a server such as a weather forecast provider and stores the information in the information storage unit 150. The calculation unit 120 sets a weather score on the basis of the weather in the area including the delivery origin and the delivery destination. The relationship between the weather and the weather score may be determined in advance. The relationship between the rejection rate and the score of the rejection rate may be appropriately determined in advance. The calculation unit 120 may determine the score of the rejection rate from the rejection rate on the basis of the relationship between the rejection rate and the score of the rejection rate. The relationship between the multiple pick rate (for example, the double pick occurrence rate) and the score may also be appropriately determined in advance. The calculation unit 120 may determine the score of the multiple pick rate from the multiple pick rate on the basis of the relationship between the multiple pick rate and the scores of the multiple pick rate. The calculation unit 120 may calculate the average delivery time in the past delivery and determine a score based on the average delivery time. In this case, the relationship between the average delivery time and the score based on the average delivery time may be appropriately determined in advance.

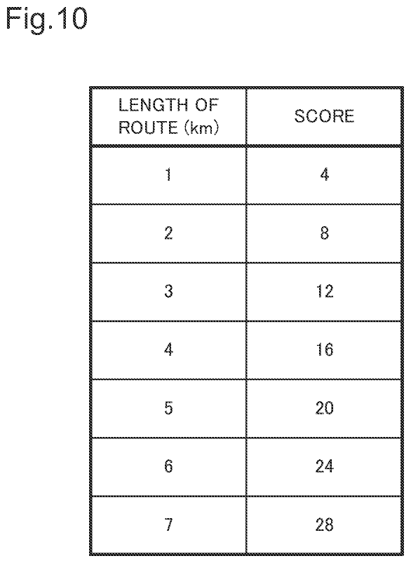

FIG. 10 is a diagram illustrating an example of scores set for a length of route. In FIG. 10, the score is expressed as “score”.

### Other Example Embodiment

Each of the delivery support device 100 and the delivery support device 101 described above can be achieved by a computer including a memory in which a program read from a storage medium is loaded and a processor that executes the program. Each of the delivery support device 100 and the delivery support device 101 can also be achieved by dedicated hardware. The delivery support device 100 and the delivery support device 101 can also be achieved by a combination of the above-described computer and dedicated hardware.

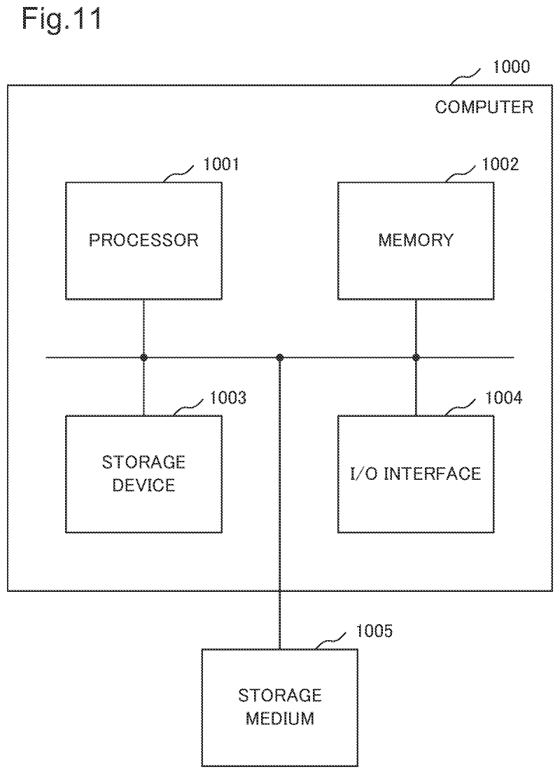

FIG. 11 is a diagram illustrating an example of a hardware configuration of a computer 1000 that can implement a delivery support device according to an example embodiment of the present disclosure. In the example illustrated in FIG. 11, the computer 1000 includes a processor 1001, a memory 1002, a storage device 1003, and an input/output (I/O) interface 1004. The computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data and programs from and in the memory 1002 and the storage device 1003. The processor 1001 can access, for example, other devices connected to the communication network 500 via an I/O interface 1004. The processor 1001 may access the storage medium 1005. The storage medium 1005 stores a program for operating the computer 1000 as the delivery support device 100 or a program for operating the computer 1000 as the delivery support device 101.

The processor 1001 loads a program for operating the computer 1000 as the delivery support device 100 or a program for operating the computer 1000 as the delivery support device 101, which is stored in the storage medium 1005, into the memory 1002. Then, the processor 1001 executes the program loaded in the memory 1002, and thereby, the computer 1000 operates as the delivery support device 100 or the delivery support device 101.

The reception unit 110, the calculation unit 120, the output unit 130, the collection unit 140, and the payment unit 160 can be achieved by, for example, the processor 1001 that executes a program loaded in the memory 1002. The information storage unit 150 can be achieved by the memory 1002 included in the computer 1000 or the storage device 1003 such as a hard disk device. A part or all of the reception unit 110, the calculation unit 120, the output unit 130, the collection unit 140, the information storage unit 150, and the payment unit 160 can be achieved by a dedicated circuit.

In recent years, the number of companies that accept online food and drink delivery is increasing.

The technologies of JP 2004 227373 A, JP 2003 030550 A, JP 2005 148909 A, and JP 2010 039961 A calculate a predicted delivery time on the assumption that a delivery agent receives one delivery object at a store and delivers the received delivery object to one delivery destination. Accordingly, it cannot be said that the technologies of JP 2004 227373 A, JP 2003 030550 A, JP 2005 148909 A, and JP 2010 039961 A can accurately calculate the predicted delivery time when above-described assumption is not necessarily satisfied, such as a case where there is a possibility of receiving two or more delivery objects at a time in one store.

The present disclosure has an effect of improving accuracy of a delivery prediction time.

Some or all of the above example embodiments can be described as the following supplementary notes, but are not limited to the following.

(Supplementary Note 1)

A delivery support device including:

a reception unit that receives information on a delivery origin and information on a delivery destination;

a calculation unit that calculates a delivery time between the delivery origin and the delivery destination on the basis of a multiple pick rate of receiving a plurality of delivery objects in one pickup from the delivery origin; and an output unit that outputs the delivery time.

(Supplementary Note 2)

The delivery support device according to Supplementary Note 1, wherein

the calculation unit calculates the delivery time further on the basis of a rejection rate which is a probability that a delivery agent rejects a delivery request of the delivery object from the delivery origin.

(Supplementary Note 3)

The delivery support device according to Supplementary Note 2, wherein

the calculation unit calculates the delivery time for each of the delivery agent on the basis of the rejection rate for each of the delivery agent, and

the output unit outputs the delivery time for each of the delivery agent.

(Supplementary Note 4)

The delivery support device according to Supplementary Note 2 or 3, wherein

the calculation unit calculates the rejection rate on the basis of information in a social networking service (SNS).

(Supplementary Note 5)

The delivery support device according to any one of Supplementary Notes 1 to 4, wherein

the calculation unit estimates the multiple pick rate on the basis of a count of delivery agent whose distance from the delivery origin satisfies a first criterion and a count of uncompleted delivery request for other delivery destination whose distance from the delivery destination satisfies a second criterion.

(Supplementary Note 6)

A delivery support method including:

receiving information on a delivery origin and information on a delivery destination;

calculating a delivery time between the delivery origin and the delivery destination on the basis of a multiple pick rate of receiving a plurality of delivery objects in one pickup from the delivery origin; and

outputting the delivery time.

(Supplementary Note 7)

The delivery support method according to Supplementary Note 6, further including

calculating the delivery time further on the basis of a rejection rate which is a probability that a delivery agent rejects a delivery request of the delivery object from the delivery origin.

(Supplementary Note 8)

The delivery support method according to Supplementary Note 7, further including:

calculating the delivery time for each of the delivery agent on the basis of the rejection rate for each of the delivery agent; and

outputting the delivery time for each of the delivery agent.

(Supplementary Note 9)

The delivery support method according to Supplementary Note 7 or 8, further including

calculating the rejection rate on the basis of information in a social networking service (SNS).

(Supplementary Note 10)

The delivery support method according to any one of Supplementary Notes 6 to 9, further including

estimating the multiple pick rate on the basis of a count of delivery agent whose distance from the delivery origin satisfies a first criterion and a count of uncompleted delivery request for other delivery destination whose distance from the delivery destination satisfies a second criterion.

(Supplementary Note 11)

A program that causes a computer to execute:

reception processing of receiving information on a delivery origin and information on a delivery destination;

calculation processing of calculating a delivery time between the delivery origin and the delivery destination on the basis of a multiple pick rate of receiving a plurality of delivery objects in one pickup from the delivery origin; and

output processing of outputting the delivery time.

(Supplementary Note 12)

The program according to Supplementary Note 11, wherein

the calculation processing calculates the delivery time further on the basis of a rejection rate which is a probability that a delivery agent rejects a delivery request of the delivery object from the delivery origin.

(Supplementary Note 13)

The program according to Supplementary Note 12, wherein

the calculation processing calculates the delivery time for each of the delivery agent on the basis of the rejection rate for each of the delivery agent, and,

the output processing outputs the delivery time for each of the delivery agent.

(Supplementary Note 14)

The program according to Supplementary Note 12 or 13, wherein

the calculation processing calculates the rejection rate on the basis of information in a social networking service (SNS).

(Supplementary Note 15)

The program according to any one of Supplementary Notes 11 to 14, wherein

the calculation processing estimates the multiple pick rate on the basis of a count of delivery agent whose distance from the delivery origin satisfies a first criterion and a count of uncompleted delivery request for other delivery destination whose distance from the delivery destination satisfies a second criterion.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A delivery support device comprising:
at least one memory configured store instructions; and
at least one processor configured to execute the instructions to:
receive information on a delivery origin and information on a delivery destination;
calculate a delivery time between the delivery origin and the delivery destination based on a multiple pick rate of receiving a plurality of delivery objects in one pickup from the delivery origin; and
output the delivery time.

2. The delivery support device according to claim 1, wherein
the at least one memory is further configured to
calculate the delivery time further based on a rejection rate that is a probability that a delivery agent rejects a delivery request of a delivery object from the delivery origin.

3. The delivery support device according to claim 2, wherein
the at least one memory is further configured to:
calculate the delivery time for each of a plurality of delivery agents based on the rejection rate for each of the plurality of delivery agents; and
output the delivery time for each of the plurality of delivery agents.

4. The delivery support device according to claim 2, wherein
the at least one memory is further configured to
calculate the rejection rate based on information in a social networking service (SNS).

5. The delivery support device according to claim 1, wherein
the at least one memory is further configured to
estimate the multiple pick rate based on a count of delivery agent whose distance from the delivery origin satisfies a first criterion and a count of uncompleted delivery request for other delivery destination whose distance from the delivery destination satisfies a second criterion.

6. A delivery support method comprising:
receiving information on a delivery origin and information on a delivery destination;
calculating a delivery time between the delivery origin and the delivery destination based on a multiple pick rate of receiving a plurality of delivery objects in one pickup from the delivery origin; and
outputting the delivery time.

7. The delivery support method according to claim 6, further comprising
calculating the delivery time further based on a rejection rate that is a probability that a delivery agent rejects a delivery request of a delivery object from the delivery origin.

8. The delivery support method according to claim 7, further comprising:
calculating the delivery time for each of a plurality of delivery agents based on the rejection rate for each of the plurality of delivery agents; and
outputting the delivery time for each of the plurality of delivery agents.

9. The delivery support method according to claim 7, further comprising
calculate the rejection rate based on information in a social networking service (SNS).

10. The delivery support method according to claim 6, further comprising
estimating the multiple pick rate based on a count of delivery agent whose distance from the delivery origin satisfies a first criterion and a count of uncompleted delivery request for other delivery destination whose distance from the delivery destination satisfies a second criterion.

11. A non-transitory computer-readable storage medium that stores a program for causing a computer to execute:
reception processing of receiving information on a delivery origin and information on a delivery destination;
calculation processing of calculating a delivery time between the delivery origin and the delivery destination based on a multiple pick rate of receiving a plurality of delivery objects in one pickup from the delivery origin; and
output processing of outputting the delivery time.

12. The storage medium according to claim 11, wherein
the calculation processing calculates the delivery time further based on a rejection rate which is a probability that a delivery agent rejects a delivery request of the delivery object from the delivery origin.

13. The storage medium according to claim 12, wherein
the calculation processing calculates the delivery time for each of a plurality of delivery agents on the basis of the rejection rate for each of the plurality of delivery agents, and
the output processing outputs the delivery time for each of the plurality of delivery agents.

14. The storage medium according to claim 12, wherein
the calculation processing calculates the rejection rate on the basis of information in a social networking service (SNS).

15. The storage medium according to claim 11, wherein
the calculation processing estimates the multiple pick rate based on a count of delivery agent whose distance from the delivery origin satisfies a first criterion and a count of uncompleted delivery request for other delivery destination whose distance from the delivery destination satisfies a second criterion.
